(19) United States
(12) Patent Application Publication
(10) Pub. No.: US 2007/0262133 A1
(43) Pub. Date: Nov. 15, 2007

(54) User Interfacing Method of Financial Settlement Using Portable Phone

(75) Inventor: Si-Woo Park, Sungnam-City (KR)

Correspondence Address: AKERMAN SENTERFITT, 801 PENNSYLVANIA AVENUE N.W., SUITE 600, WASHINGTON, DC, 20004, US

(73) Assignee: Harexinfotech, Inc., Seoul (KR)

(21) Appl. No.: 10/569,943

(22) PCT Filed: Aug. 29, 2003
(86) PCT No.: PCT/KR03/01754

§ 371 Date: Apr. 5, 2007

(51) Int. Cl. G07F 19/00

(52) U.S. Cl. 235/379

(57) ABSTRACT

A user interfacing method of financial settlement using a mobile enables a user to select one among a number of financial settlement cards contained in the mobile unit as a default card, and to perform an immediate settlement as the selected default card. When a menu is displayed on a settlement display screen, cards are classified by places of uses. A soft key is provided to easily achieve a menu shift. Communications are performed between the mobile unit (MU) and the base unit (BU) of the card terminal, by pressing an external key provided on an appropriate outer portion of the MU one time. Thus, the BU transmits an identifier includes information about a card to be used for settlement according to each use and whether or not a password is required, and the MU transmits necessary settlement information based on the received identifier to thereby perform a settlement.

### RELATED APPLICATIONS

This application is a U.S. National Stage entry under 35 USC 371 of PCT/KR2003/001754, filed Aug. 29, 2003, the benefit of the filing date of which is hereby claimed.

### TECHNICAL FIELD

The present invention relates to a financial settlement system using a portable phone, and more particularly, to a user interfacing method of allowing a user to use a number of financial settlement cards contained in a portable phone more conveniently in various ways according to many uses.

### BACKGROUND ART

A number of prior art references are disclosed by the same applicant as that of this application, in which case financial settlement can be done by using a personal portable terminal where an optical transceiver such as a portable phone or a personal digital assistance (PDA) is attached, instead of a plastic or magnetic card. There are Korean Patent Application No. 2000-13426 entitled “Commercial transaction system using a mobile phone” and Korean Patent Publication No. 2001-112562 entitled “Settlement method using mobile phone” as an example, respectively. In these prior art, an optical transceiver is attached in a portable mobile phone, and an optical receiver is attached in a credit inquiry terminal. Accordingly, since card information is contained in the mobile phone where the optical transceiver is attached, transactions can be performed via optical transmission and reception between the mobile phone and the credit inquiry terminal, instead of a credit card.

As another example, there is PCT published application WO 98/34203 A1 (published on 6 Aug. 1998) entitled “Method and apparatus for performing financial transactions using a mobile communication unit”. In this prior art, it is disclosed that financial identification codes (ID's) are stored directly within a mobile communications unit such as a mobile phone or other device, which represent credit or debit accounts, digital money or other financial entities. The ID's are transmitted by radio or infrared signals to enable purchase transactions.

As yet another example, there is PCT published application WO 02/80122 A1 (published on 10 Oct. 2002) entitled “Method and system for settling financial transaction with mobile communications portable terminal containing financial information”. In this art, financial information is encrypted by using a customer's inherent electronic wallet management number such as a secret number at the time of application of a card issuance, and then the encrypted financial information is input to a mobile communications terminal directly, or via a communications network. When a customer wishes to settle financial transactions, he or she inputs his or her electronic wallet management number (such as a secret number) to optically transmit the encrypted financial information and electronic wallet management number (such as a secret number) to a POS terminal or card inquiry machine in an affiliated store. The POS terminal or card inquiry machine decodes the encrypted financial information by using the received electronic wallet management number such (as a secret number).

As still another example, there is U.S. Pat. publication No. 6,016,476 (issued 18 Jan. 2000) entitled “Portable information and transaction processing system and method utilizing biometric authorization and digital certificate security”. In this art, a user can store his or her credit card, ATM card and/or debit care (i.e., financial) information as well as personal information, and then access and write selected information to a smartcard, which is then used to initiate a POS, ATM, or consumer transaction. User inquiry is performed using a PIN or password, and financial information for each card stored in the PDA is secured.

As yet another example, there is PCT published application WO 02/065404 A2 (published on 22 Aug. 2002) entitled “Identification system”. In this art, a card is selected on the menu of a cellular phone and is transmitted as a serial data stream.

As yet still another example, there is GB patent application no. 2 353 389 A (published on 21 Feb. 2001) entitled “Self-service terminal”. In this art, a self-service terminal for dispensing electronic vouchers for storing in a portable terminal.

By the way, information about a number of financial settlement cards such as a credit card, a debit card, a cash card, and a department store card is contained in an internal or external memory of a mobile unit which can be used as a financial settlement unit. However, since a card to be used for financial settlement is selected according to uses, or since there are financial transactions which do not require a password as in petty cash dealings and financial transactions requiring a password, an interface allowing a user to use a desired card more easily according to a transaction situation, need to be embodied.

### DISCLOSURE OF THE INVENTION

To solve the above problems, it is an object of the present invention to provide a user interfacing method of making a card to be used as default selected according to each use, and allowing a user to settle financial transactions immediately with the selected default card.

It is another object of the present invention to provide a user interfacing method of settling financial settlement based on a mobile unit on an outer portion of which an external key is provided, in which an identifier for a card to be settled is received in the mobile unit when the external key is pressed one time, to thus perform financial settlement.

To accomplish the above object of the present invention, there is provided a user interfacing method of performing financial settlement using a mobile unit, the user interfacing method comprising the steps of: (a) selecting one of a number of financial settlement cards contained in the mobile unit as a default card; (b) if a user selects a mobile unit settlement on an initial menu display screen of the mobile unit, displaying on a screen a mobile unit settlement menu including an immediate settlement item which enables an immediate settlement to be performed immediately with the selected default card; (c) if the user selects the immediate settlement item on the mobile unit settlement display screen, displaying a password input screen of the default card to be used as the immediate settlement card, together with soft keys allocated to replace the settlement card by a new settlement card; and (d) if the user inputs a password on the password input screen and the input password is normally processed, displaying a screen informing the user that the settlement has been completed, and if the user selects the soft keys allocated on the password input screen, displaying the contained financial settlement cards to enable the user to select a settlement card.

There is also provided a user interfacing method of performing financial settlement using a mobile unit in which information is transmitted and received between a mobile unit and a base unit connected to a card terminal, the user interfacing method comprising the steps of: (a) communicating with the base unit by pressing one time an external key provided on an outer portion of the mobile unit; (b) transmitting an identifier from the base unit to the mobile unit in which the identifier includes information about a card to be used for settlement according to each use and whether or not a password is required; (c) receiving the identifier at the mobile unit, and transmitting only corresponding card information to the base unit if a password is not required to thereby complete a settlement, and displaying a password input screen of a corresponding card if a password is required; and (d) if a password is input on the password input screen by the user and normally processed, displaying a screen informing the user that the settlement has been completed.

### BRIEF DESCRIPTION OF THE DRAWINGS

The above objects and other advantages of the present invention will become more apparent by describing the preferred embodiments thereof in more detail with reference to the accompanying drawings in which:

FIG. 1 is a perspective view schematically showing a financial settlement system using a mobile unit in which the present invention is applied;

FIGS. 2A and 2B shows a screen of the mobile unit showing a user interfacing process for immediate settlement; and

FIGS. 3A through 3D show a screen of the mobile unit showing a user interfacing process using an external key.

### BEST MODE FOR CARRYING OUT THE INVENTION

A preferred embodiment of the present invention will be described in detail with reference to the accompanying drawings.

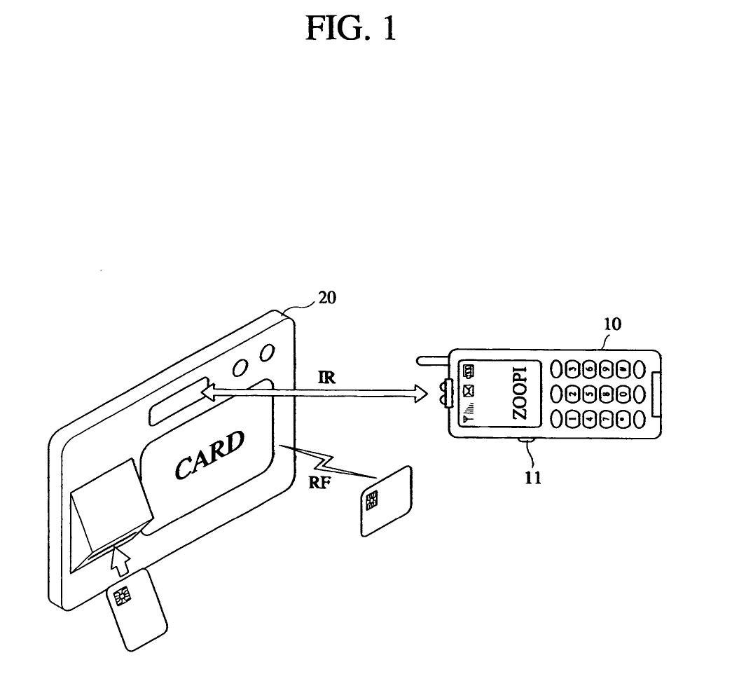

As shown in FIG. 1, a financial settlement system includes a mobile unit (MU) 10 containing financial settlement/ID card information, and a base unit (BU) 20 receiving the financial settlement/ID card information through communication with the mobile unit (MU) 10. A radio frequency (RF) chip, an infrared (Ir) module, or a bluetooth module is mounted on the mobile unit (MU) 10 and the base unit (BU) 20, to be communicated with each other. The base unit (BU) 20 is connected to a card terminal (not shown) via cable, or mounted or contained in the card terminal. The card terminal is connected to a financial settlement/ID certifying server via a VAN (Value Added Network).

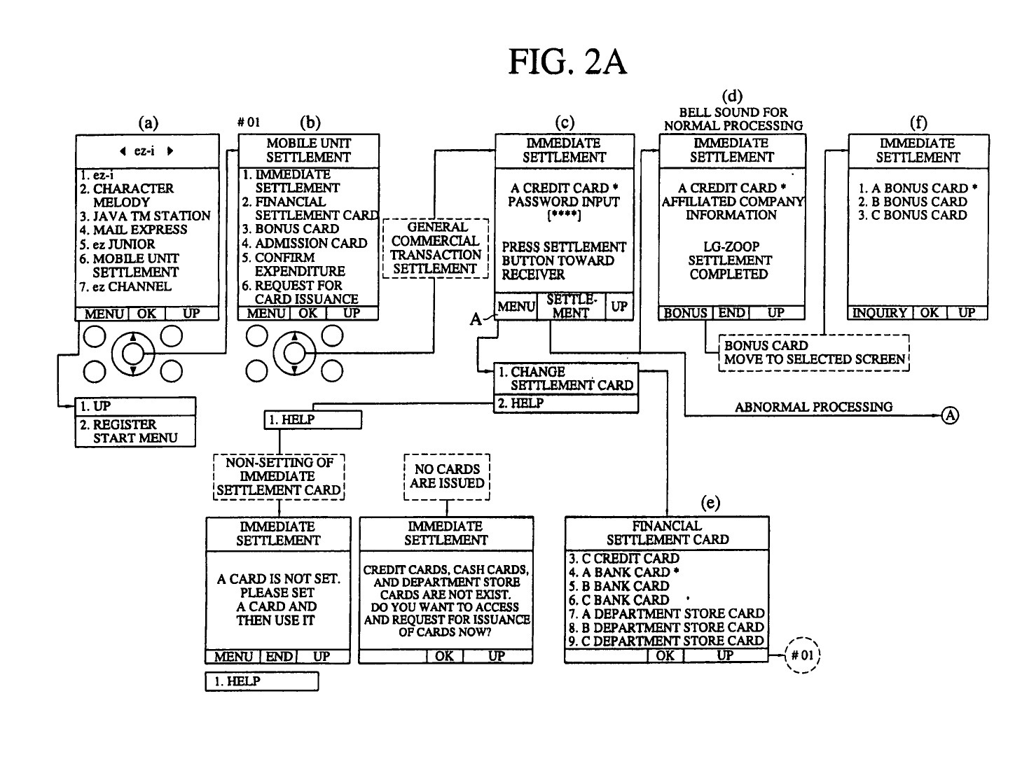

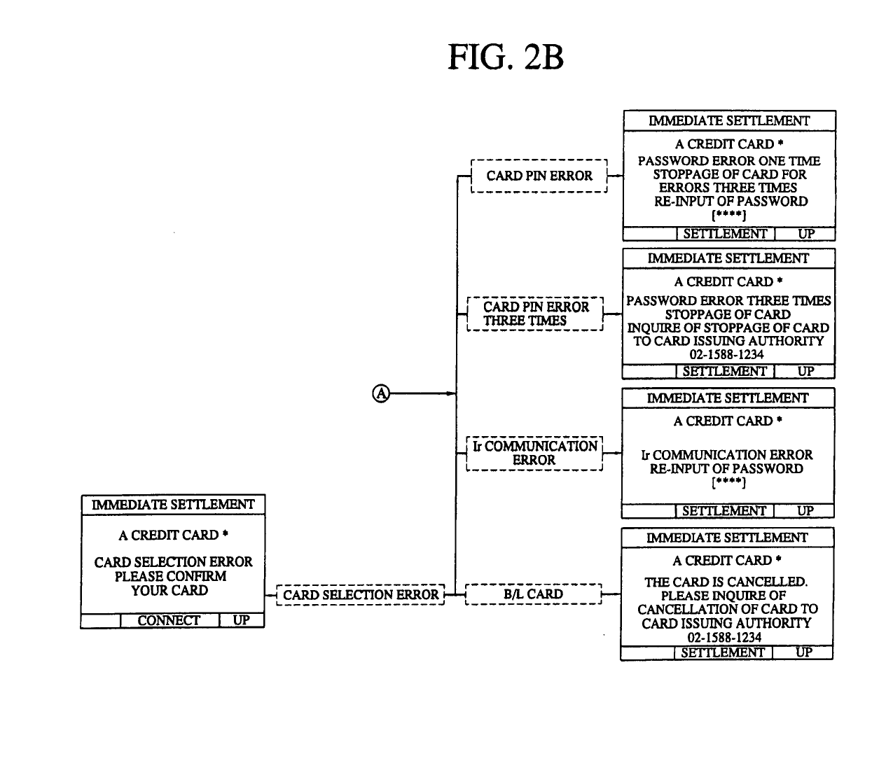

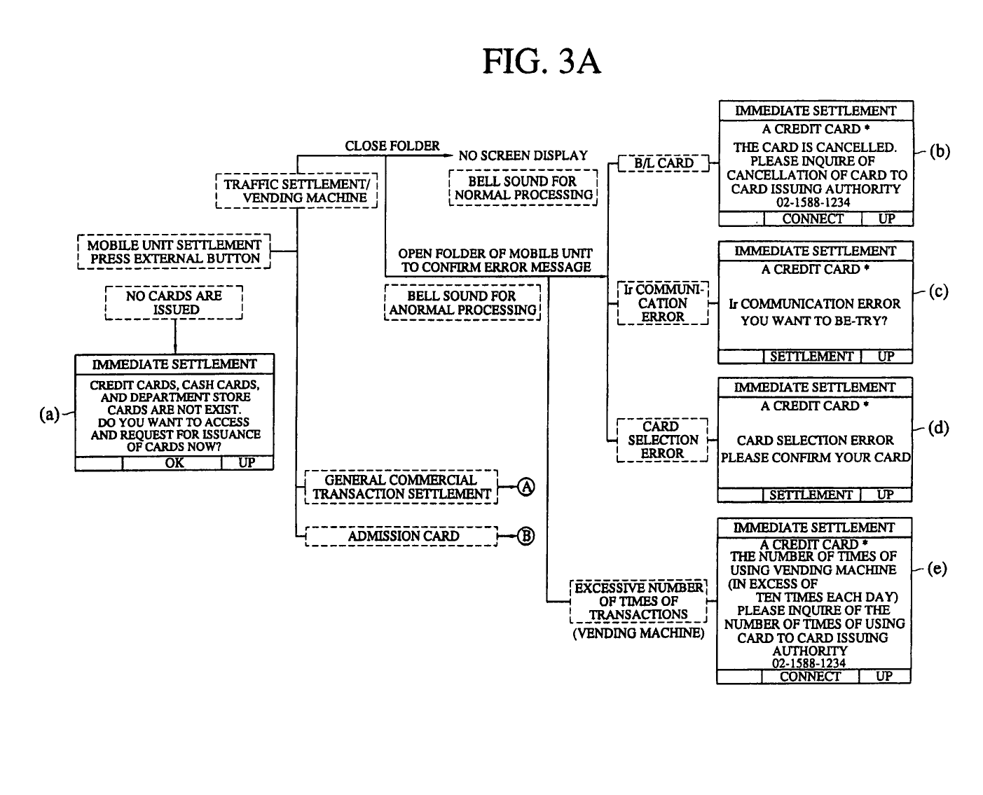

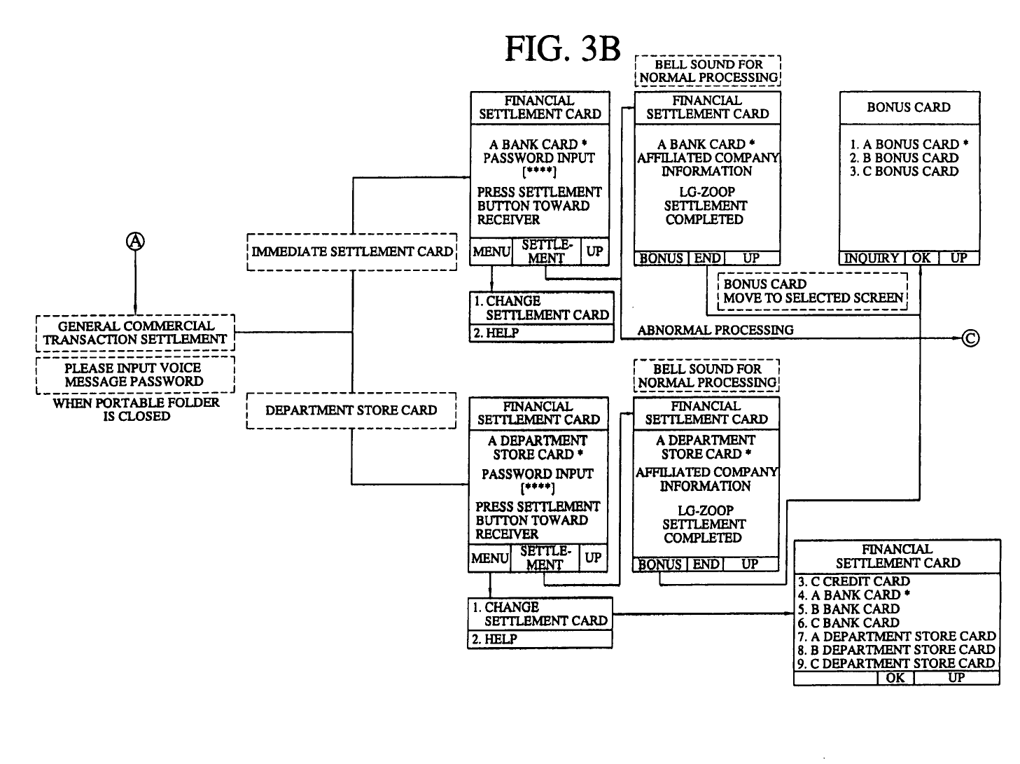

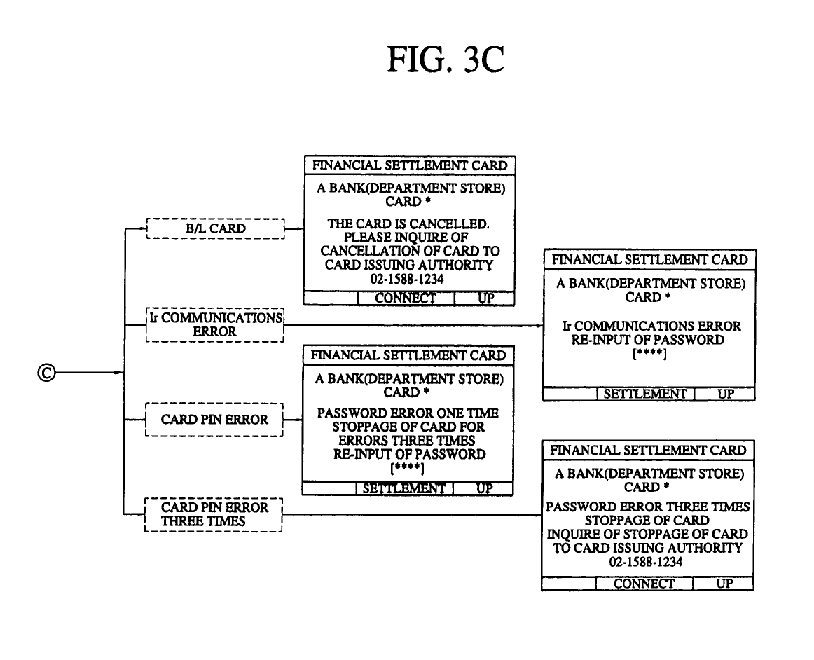

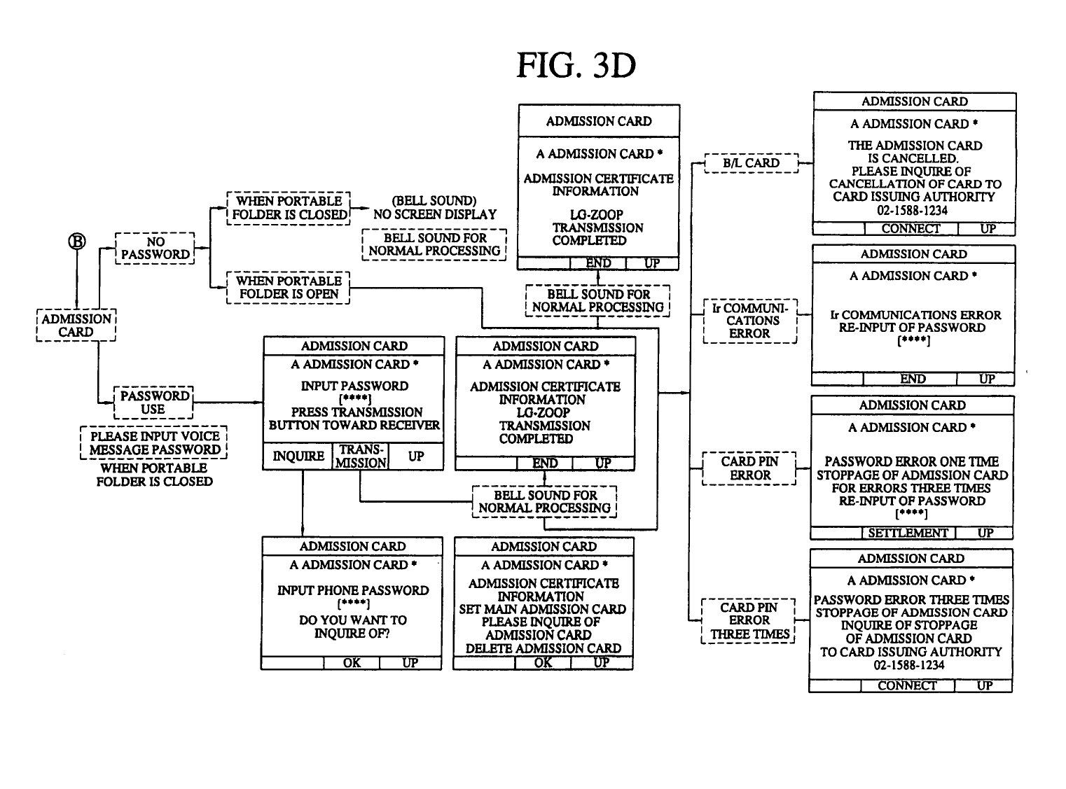

A process of performing financial settlement via a user interface with the mobile unit (MU) 10 in the financial settlement system using the mobile unit (MU) 10, will be described with reference to FIGS. 2A through 3D.

Since information on a number of financial settlement cards is contained in the mobile unit (MU) 10, a user must select a card to be used as a settlement card each time he or she need to select a desired card to be used as a settlement card according to each situation of transactions. Thus, the present invention selects one of a number of financial settlement cards contained in the mobile unit (MU) 10 as a default card. That is, the present invention employs an immediate settlement method of immediately settling financial transactions with the default card. A user interface screen related to the immediate settlement is shown in FIGS. 2A and 2B.

Referring to FIGS. 2A and 2B, a user manipulates a keypad on a financial settlement menu shown as a screen (a) of FIG. 2A in the mobile unit (MU) 10 which can be used as a financial settlement unit and selects a portable phone settlement of No. 6. Then, the mobile unit (MU) 10 is set into a portable phone settlement menu.

Thus, items such as an immediate settlement (particular bank name), a financial settlement card, a bonus card, an admission card, a use-particulars confirmation, and a card issuance request, are displayed on the display as a screen (b) of FIG. 2A. In the screen (b) of FIG. 2A, a default card is displayed as the immediate settlement item, so that a user can easily recognize a card which has been selected as a default card in advance. When a user wishes to settle a general commercial transaction with a card selected as a default card, he or she manipulates a keypad on the screen (b) of FIG. 2A in the mobile unit (MU) 10 to then press a button of No. 1 in order to select the immediate settlement.

Then, the mobile unit (MU) 10 displays an immediate settlement screen (c) on the display in FIG. 2A. In this state, the user inputs a password and presses a settlement button, to thus transmit information on the financial settlement card selected as a corresponding default card to the base unit (BU) 20, together with the password as settlement information. On the screen for inputting an immediate settlement card password is assigned soft keys allowing the user to replace a settlement card by a new settlement card. That is, on the lower portion of the screen (c) of FIG. 2A are displayed soft keys “A” such as a menu, a settlement, and a high rank page. If a user manipulates direction keys on the keypad in the mobile unit (MU) 10, and makes a cursor located on the “menu” to select the menu button, two sub-menus such as “No. 1 settlement card replacement” and “No. 2 help” are displayed on the screen. If a user presses a “No. 1 key” on the keypad in the mobile unit (MU) 10, financial settlement cards are displayed on a screen (e) of FIG. 2A, so that he or she can see the kinds of the financial settlement cards contained in the mobile unit (MU) 10. A card marked with a symbol “*” among the card lists means an immediate settlement card set by the user. That is, a card selected as a default card is processed and displayed on the screen with a separate display symbol, a character display, or a hight light display so that users can identify the card easily. When a financial settlement card is initially downloaded in the mobile unit (MU) 10, the downloaded card is selected as a default card without any separate appointment of the default card. In the case that the card designated as a default card is deleted during use, and thus only one financial settlement card exists, the card is automatically designated as a default card. In the case that a default card set as an immediate settlement card is deleted, a message of informing a user of deletion of the default card will be output before or after deletion thereof. Through the immediate settlement, users can settle their commercial transactions immediately by using a default card with no need to select a card to be used each time the commercial transactions occur. If a user selects a high rank menu on the screen (e) of FIG. 2A through the soft keys displayed at the portion “A” in the lower portion of the screen of the mobile unit (MU) 10, the display in the mobile unit (MU) 10 returns to the screen (b) of FIG. 2A. When a user presses a settlement button on the screen (c) of FIG. 2A, the display of the mobile unit (MU) 10 is shifted to the screen (d) of FIG. 2A, to thereby inform the user that the settlement has been completed. Also, the mobile unit (MU) 10 can inform the user that a settlement has been completed through an effect sound such as a bell sound, and a sound guidance message output. As described above, soft keys are assigned so that a user can easily use a bonus card after completion of a settlement such as a general commercial transaction settlement. That is, in the lower portion of the screen (d) of FIG. 2A are displayed soft keys allowing users to select one of three keys such as bonus, end, and high rank. If a user manipulates a keypad in the mobile unit (MU) 10, and selects a soft key assigned as bonus, a screen (f) of FIG. 2A is displayed. It is natural that the display in the mobile unit (MU) 10 be automatically shifted from the screen (d) of FIG. 2A to a bonus card selection screen such as a screen (f) of FIG. 2A.

Meanwhile, there is also a user interfacing method of performing financial settlement by pressing an external key 11 provided on an appropriate outer portion in the mobile unit (MU) 10 one time without using a keypad in the mobile unit (MU) 10. The user interface screens related to the external key 11 are shown in FIGS. 3A to 3D.

If a user presses the external key 11, the mobile unit (MU) 10 communicates with the base unit (BU) 20 connected to a card terminal (not shown). The mobile unit (MU) 10 can recognize pressure of the external key 11 even when the external key 11 is pressed for a very short time, or for several mili-seconds or longer. In the case of a portable phone, the mobile unit (MU) 10 can recognize pressure of the external key 11, no matter where the flip or folder thereof is open or closed. The mobile unit (MU) 10 displays a screen (a) of FIG. 3A to enable a user to request for a card issuance, if the external key 11 is pressed but there is no card information contained therein, that is, if a card has not yet been issued. The base unit (BU) 20 transmits an identifier to the mobile unit (MU) 10, in which the identifier includes the kind of a card to be used for settlement and the information about whether or not a password is needed. In general, no passwords are needed for financial transactions using traffic fares, use of vending machines, petty cash payments, and entrance certificates, and passwords are needed for financial transactions using default cards and department store settlement cards. The mobile unit (MU) 10 receives an identifier from the base unit (BU) 20 and transmits only necessary card information if no passwords are needed, to then complete the transaction. In this case, if the folder of the mobile unit (MU) 10 is in the closed state, a bell sound informing the users that the transaction has been normally processed is output without displaying a particular screen. If the transaction is not normally processed, an error message is displayed on the screen to make the user confirm that the transaction is not normally processed. That is, when user opens the folder of the mobile unit (MU) 10 in order to confirm the error message, the screens (b) through (e) of FIG. 3A are displayed according to the causes of the errors. There are blacklist (B/L) cards, Ir communications errors, card selection errors, and the excessive number of transactions, as the causes of errors. The excessive number of transactions is applied only in vending machines. In this case, the mobile unit (MU) 10 or the base unit (BU) 20 store and manage the number of times of daily uses and an amount of daily paid money, and stop the card function if the number of daily uses and an amount of daily paid money meet a particular condition, while making the card function re-used if the limited condition is released. That is, the number of times by which the card can be used is determined by cards to be used or portable terminals, to thus restrict a financial settlement function stored in the mobile unit (MU) 10. The number of times of uses can be selected daily, monthly or by an amount of money, to fit for circumstances of places where cards are used. The mobile unit (MU) 10 receives an identifier from the base unit (BU) 20, and automatically activates a password input window if a password is needed. If the folder of the mobile unit (MU) 10 is in the closed state, sound of a “password input guidance message” is output. At the state where the password input window has been activated, connection of communications between the mobile unit (MU) 10 and the base unit (BU) 20 is interrupted. The reason is to prevent a communication cost from being incurred due to generation of an air-time. FIGS. 3B to 3D show a general commercial transaction and an admission card which require a password as an example, respectively. If a user inputs a password on a password input window in a mobile unit (MU) 10 and then presses a settlement button, a transaction is established. The mobile unit (MU) 10 displays an error message when a card password has been erroneously input therein. Thereafter, user interface processes of FIGS. 3B to 3D are identical with the interface process described referring to FIGS. 2A and 2B.

Also, cards stored in the mobile unit (MU) 10 are classified by purposes of uses, to thereby make the user conveniently select a desired card. For example, cards are classified into a membership card, a bonus card, a family card, an admission security card, a petty cash settlement card, a traffic card, a general commercial transaction card, a bank card, a debit card, a cash card, a credit card, etc. Particular cards corresponding to a sub-list of each classification are displayed. An icon or menu with which a related other item is selected to move to a corresponding screen is provided at the time of performing a settlement process. For example, an icon or menu with which another card can be selected on a card password input screen is provided at the time of performing a settlement with an immediate settlement card, and then a financial settlement completion message is displayed. Then, a menu or icon with which information which allows a user to receive an additional service as in a bonus card can be selected, is provided.

In the case that a user wishes to access an access limited item in the mobile unit (MU) 10, a phone password is used as an access key. Here, the access limited item is an item relating to setting and inquiry of various cards, and the phone password is a password which is used for setting or releasing a phone locking function.

As described above, the user interfacing method of financial settlement using a mobile unit according to the present invention, selects a card to be used as a default card among a number of financial settlement cards and enables a user to perform an immediate settlement without selecting a desired settlement card each time. Also, a user interface according to the present invention is provided with an external key on an appropriate outer portion of a mobile unit, in which the mobile unit communicates with a base unit connected to a card terminal and thus receives the kind of the card and information whether a password is required, by depressing the external key one time, to thereby perform an adaptable settlement. Accordingly, the present invention provides an effect of making a user perform financial settlement more conveniently by using a mobile unit.

### INDUSTRIAL APPLICABILITY

As described above, the user interfacing method of financial settlement using a mobile unit according to the present invention can be used to select a settlement card to be applied differently for each business purpose, in a card application field such as a credit card, a debit card, a department store card, a membership card, a bonus card, a family card, an admission security card, etc.

The present invention is not limited in the above-described embodiments. It is apparent to one who is skilled in the art that there are many variations and modifications without departing off the spirit of the present invention and the scope of the appended claims.

1-19. (canceled)

20. A user interfacing method of performing financial settlement using a mobile unit, the user interfacing method comprising the steps of:
(a) selecting one of a number of financial settlement cards contained in the mobile unit as a default card;
(b) if a user selects a mobile unit settlement on an initial menu display screen of the mobile unit, displaying on a screen a mobile unit settlement menu including an immediate settlement item which enables an immediate settlement to be performed immediately with the selected default card;
(c) if the user selects the immediate settlement item on the mobile unit settlement display screen, displaying a password input screen of the default card to be used as the immediate settlement card, together with soft keys allocated to replace the settlement card by a new settlement card, and then outputting a password input guiding message as a sound signal; and
(d) if the user inputs a password on the password input screen and the input password is normally processed, displaying a screen informing the user that the settlement has been completed, and if the user selects the soft keys allocated on the password input screen, displaying the contained financial settlement cards to enable the user to select a settlement card.

21. The user interfacing method of claim 1, wherein a financial settlement card contained initially in the mobile unit is selected as default, and only one financial settlement card existing in use is selected as default, in said step (a).

22. The user interfacing method of claim 1, wherein the message informing of a deletion of the default card will be output before or after deletion thereof, in the case that selected default card is deleted, in said step (a).

23. The user interfacing method of claim 1, wherein the kind of a default card is displayed on the mobile unit settlement menu screen together with the immediate settlement item, in said step (b).

24. The user interfacing method of claim 1, wherein said step (d) further comprises the step of (e) providing a menu or icon with information which allows a user to receive an additional service as in a bonus card can be selected.

25. The user interfacing method of claim 1, wherein a soft key for allowing a user to select a bonus card is assigned and displayed on the settlement completion screen, in said step (d).

26. The user interfacing method of claim 1, wherein a separate mark is added to the default card when the kind of a financial settlement card is displayed, to thereby make a user easily recognize the kind of the card, in said step (d).

27. The user interfacing method of claim 8, wherein the card to be selected as a default card is processed with characters or highlight indication, in said step (d).

28. The user interfacing method of claim 1, wherein an error message is displayed when a cancelled card is selected, in said step (d).

29. The user interfacing method of claim 9, wherein a card selection error message is displayed when a card which cannot be used for a particular purpose is selected, in said step (d).

30. The user interfacing method of claim 9, wherein a phone password is used as an access key when a user wishes to access an access limited item in the mobile unit.

31. The user interfacing method of claim 11, wherein the phone password is a password which is used when a phone locking function is set and released.

32. A user interfacing method of performing financial settlement using a mobile unit in which information is transmitted and received between a mobile unit and a base unit connected to a card terminal, the user interfacing method comprising the steps of:
(a) communicating with the base unit by pressing one time an external key provided on an outer portion of the mobile unit;
(b) transmitting an identifier from the base unit to the mobile unit in which the identifier includes information about a card to be used for settlement according to each use and whether or not a password is required;
(c) receiving the identifier at the mobile unit, and transmitting only corresponding card information to the base unit if a password is not required to thereby complete a settlement, and displaying a password input screen of a corresponding card if a password is required; and
(d) if a password is input on the password input screen by the user and normally processed, displaying a screen informing the user that the settlement has been completed.

33. The user interfacing method of claim 13, wherein said step (c) comprises the step of interrupting connection of communications between the mobile unit and the base unit so as to prevent a communication cost from being incurred due to generation of an air-time in the displayed condition.

34. The user interfacing method of claim 13, wherein an error message is displayed when a password input error occurs, in said step (d).

35. The user interfacing method of claim 13, wherein said step (d) comprises the step of outputting an effect sound and a voice guiding message which inform the user that a settlement is completed.

36. The user interfacing method of claim 13, further comprising the step of (e) defining the number of times of the financial transactions using the mobile unit which is allowed at a particular business place, for each card, to thereby limit a financial settlement function.

37. The user interfacing method of claim 17, wherein the number of times of financial transactions is selected daily, monthly or by an amount of money, to fit for circumstances of places where cards are used, in said step (e).

38. A user interfacing method of financial settlement using information transmission and reception between a mobile unit and a base unit connected to a card terminal, the user interfacing method comprising the steps of:
(a) performing communications between the mobile unit and the base unit of the card terminal, by pressing an external key provided on an appropriate outer portion of the mobile unit one time; and
(b) transmitting card information and/or a password of a pre-selected default card from the mobile unit to the base unit, to thereby perform a settlement.
